(19) United States
(12) Patent Application Publication
(10) Pub. No.: US 2015/0368545 A1
(43) Pub. Date: Dec. 24, 2015

(54) METHOD FOR ENHANCED RECOVERY OF OIL FROM OIL RESERVOIRS

(71) Applicant: E.I. DU PONT DE NEMOURS AND COMPANY, Wilmington, DE (US)

(72) Inventors: Scott Christopher Jackson, Wilmington, DE (US); Graham Sworn, Montlignon (FR); Donna Lynn Visioli, Lower Gwynedd, PA (US)

(21) Appl. No.: 14/761,725

(22) PCT Filed: Dec. 9, 2013
(86) PCT No.: PCT/US13/73839

§ 371 Date: Jul. 17, 2015

Related U.S. Application Data
(60) Provisional application No. 61/738,549, filed on Dec. 18, 2012.

(51) Int. Cl. C09K 8/588; E21B 43/40; E21B 43/16

(52) U.S. Cl. CPC C09K 8/588; E21B 43/16; E21B 43/40

(57) ABSTRACT

The present invention provides a method for recovering oil from a subterranean reservoir using waterflooding, wherein the flooding fluid used in the waterflooding process comprises water and a pyruvate-rich xanthan gum having at least 5 weight % pyruvate. The use of a pyruvate-rich xanthan gum is expected to increase the recovery of oil by improving both the oil/water mobility ratio and the sweep efficiency in reservoirs with a high degree of heterogeneity.

### CROSS-REFERENCE TO RELATED APPLICATIONS

This application claims the benefit of the U.S. Provisional Application No. 61/738,549, filed on Dec. 18, 2012.

### FIELD OF THE INVENTION

The present invention relates to a process for recovering crude oil from oil reservoirs using a flooding fluid comprising water and a pyruvate-rich xanthan gum.

### BACKGROUND OF THE INVENTION

In the recovery of oil from oil-bearing reservoirs, it is typically possible to recover only minor portions of the original oil in place by primary recovery methods which utilize only the natural forces present in the reservoir. Thus a variety of supplemental techniques have been developed and used to increase oil recovery. A commonly used secondary technique is waterflooding which involves injection of water into the oil reservoir. As the water moves through the reservoir, it displaces oil therein to one or more production wells through which the oil is recovered. One problem encountered with waterflooding operations is the relatively poor sweep efficiency of the water, i.e., the water can channel through certain portions of the reservoir as it travels from the injection well(s) to the production well(s), thereby bypassing other portions of the reservoir. Poor sweep efficiency may be due, for example, to differences in the mobility of the water versus that of the oil, and permeability variations within the reservoir which encourage flow through some portions of the reservoir and not others.

Various enhanced oil recovery techniques have been used to improve sweep efficiency. One way is to reduce the differences in the mobility of the water versus the oil by thickening the water with a water soluble polymer. Polyacrylamides or partially hydrolyzed polyacrylamides have been used for oil recovery by thickening the water and reducing the mobility of the water versus the oil. Polyacrylamides do not work well in highly saline conditions, such as greater than 10 parts per thousand total dissolved solids (TDS) because they lose their ability to viscosify highly saline solutions. Polysaccharides have also been used (Larry W. Lake, Enhanced Oil Recovery, Society of Petroleum Engineers, 2010, pages 314-353).

Another such technique involves increasing the viscosity of the water using non-biodegradable thickening agents such as polyvinyl aromatic sulfonates as described in U.S. Pat. No. 3,085,063.

Surfactants have been also used in aqueous media for enhanced oil recovery. Surfactants have been found to effectively lower the interfacial tension between oil and water and enable mobilization of trapped oil through the reservoir. For example, U.S. Pat. No. 8,163,678 describes methods for enhanced oil recovery using a surfactant formulation comprising (a) an alkylaromatic sulfonate; (b) an isomerized olefin sulfonate (c) a solvent; (d) a passivator; and (e) a polymer. Polymers disclosed therein include xanthan gum, partially hydrolyzed polyacrylamides (HPAM) and copolymers of 2-acrylamido-2-methylpropane sulfonic acid and/or sodium salt and polyacrylamide (PAM) commonly referred to as AMPS copolymer. Molecular weights (M_{w}) of the polymers range from about 10,000 daltons to about 20,000,000 daltons. Polymers are used in the range of about 500 to about 2500 ppm concentration, in order to match or exceed the reservoir oil viscosity under the reservoir conditions of temperature and pressure.

In addition to demonstrating good viscosifying at low shear and low concentration, several other attributes are desirable for viscosity enhancers to be useful in oil recovery. For off-shore drilling operations, sea water is used for waterflooding, so good solubility of the viscosity enhancer in cold, highly saline water is very desirable. The salinity of the water in subterranean hydrocarbon reservoirs may also vary a great deal. For example, the Minas oil field in Indonesia has total dissolved solids of between 0.2 and 0.3 weight percent. Other reservoirs may have salinities as high as or higher than 2.0 percent sodium chloride and over 0.5 percent calcium chloride and magnesium chloride. Still other reservoirs can have total dissolved solids in excess of 6 weight percent and in some cases in excess of 20 weight percent. For these high salt brines, the divalent ion concentrations including calcium and magnesium, can well be in excess of 0.1 weight %. Salinity and the presence of divalent ions including calcium and magnesium can have an effect on the phase behavior of the various chemicals used in oil recovery.

It is also desirable that the viscosity enhancer is thermally stable, because the oil field deposit may be geothermally heated. Most reservoirs are warm but cool down near the injector well under prolonged water flood. Near the injector well bore, the temperatures are near 25° C. As the water moves away from the injector to the production well, temperatures rise and the amount of oil that is likely to be left in the formation also increases as distance away from the injector to the production well increases. Hence it is desirable to have a water soluble polymer that increases the solution viscosity at low shear and at a high temperature, e.g., 80° C.

It is also desirable that the water/brine soluble polymer used be stable for the long periods needed for the polymer solutions to transit the oil reservoir from the injector well to the producer well. Hence it is desirable to use a polymer that is stable against hydrolytic, thermal and anaerobic (no air present) biological degradation. It is also desirable that the polymer solution not degrade under the high shear conditions encountered by the solution as it is pumped by a high pressure pump or at high shear zones in throttle valves used to regulate water flows into the injector wells. It is important that the polymer in solution is not retained in the rock matrix in the oil reservoir. That is, only a small amount of polymer can be removed from the solution by adsorption or retention on or in the rock matrix. Otherwise the treatment becomes ineffective if the polymer is removed from the brine solution. Finally, biodegradability in air or aerobic conditions and/or sourcing from renewable resources are also desirable especially when the polymer solution that is eventually coproduced with the oil is disposed of at sea or in waste water treatment facilities. There is therefore a need for a method to improve sweep efficiency of waterflooding operations using cost-effective, biodegradable materials that exhibit shear-thinning properties and thus exhibit lower viscosity during injection and increased viscosity in the oil reservoir. U.S. Patent Application Publication 2012/0021112 discloses certain xanthan gums with improved characteristics. In particular, the xanthan gums are obtained from Xanthomonas campestris strains, pathovar cynarae CFBP 19, juglandis CFBP 176, pelargonii CFBP 64, phaseoli CFBP 412 or ATCC 17915, celebenois ATCC 19046, or corylina CFBP 1847 or from a derivative or progeny thereof.

### SUMMARY OF THE INVENTION

This invention relates to the recovery of oil from a subterranean reservoir using waterflooding. In one aspect, this invention provides a method for recovering oil from a reservoir by water flooding, comprising:
(a) introducing an aqueous flooding fluid into the reservoir, wherein at least one portion of said flooding fluid comprises a xanthan gum characterized as having a pyruvic acid content of at least 5.0 weight % (w/w);
(b) displacing oil in the reservoir with said flooding fluid into one or more production wells, whereby the oil is recoverable.

In another aspect, this invention is an aqueous flooding fluid for enhanced oil recovery, wherein at least one portion of said flooding fluid comprises water and 0.007 to 3 weight % a xanthan gum characterized by pyruvic acid content of at least 5.0 weight %.

In another aspect, the present invention provides a method of making an aqueous flooding fluid for use in waterflooding, comprising:
(a) providing a xanthan gum characterized by pyruvic acid content of at least 5.0% (w/w); and
(b) adding the xanthan gum to at least one portion of water used in waterflooding.

In another aspect, the invention provides a method for recovering oil from a reservoir by waterflooding, comprising:
(a) introducing an aqueous flooding fluid into the reservoir, wherein at least one portion of the flooding fluid comprises 0.007 to 3 weight % of a xanthan gum characterized by pyruvic acid content of at least 5.0 weight % (w/w);
(b) displacing oil in the reservoir with said flooding fluid into one or more production wells, whereby the oil is recoverable.

### BRIEF DESCRIPTION OF THE FIGURES

FIG. 1 shows plots of the effect of pyruvate content on the viscosity temperature profile of 0.5 weight % xanthan gum in 0.1% sodium chloride solutions.

FIG. 2 shows plots of the midpoint transition temperature as a function of salt concentration for 0.5 weight % xanthan gum solutions.

FIG. 3 shows plots on the effect of thermal degradation on apparent viscosity of xanthan gum solutions at low shear of 1 sec⁻¹ in salt water.

### DETAILED DESCRIPTION

The following definitions are provided for the special terms and abbreviations used in this application:

The term “pyruvate-rich xanthan” as used herein refers to a xanthan gum characterized by a pyruvic acid content of at least 5.0% (w/w), in which the pyruvic acid is incorporated into the xanthan as pyruvate ester moieties. The term “gum” refers to a non-starch, non-pectin carbohydrate polymer derived from land or sea plants, or microorganisms.

The term “water” refers to water that can be supplied from any suitable source, and can include, for example, sea water, brine, production water, water recovered from an underground aquifer, including those aquifers in contact with the oil, or surface water from a stream, river, pond or lake. As is known in the art, it may be necessary to remove particulates from the water prior to injection into the one or more wells. Water also includes various “synthetic” brines or sea water having defined total dissolved solids.

As used herein, the abbreviation “ppt” stands for parts per thousand. “Total dissolved solids” (TDS) refers to the amount of inorganic material in the water as described herein, and does not include any dissolved polymer material that may be present in the water.

The term “mobility” is defined as the ratio of the relative permeability of the fluid to its viscosity at reservoir conditions. The relative permeability for water is evaluated at the average water saturation of the swept zones of the oil reservoir, typically at residual oil saturation. Here water saturation refers to the fraction of the void volume occupied by water. The relative permeability of the oil is evaluated at the oil saturation of the unswept zone in the oil reservoir, typically at residual water saturation (Boatright, K E, 2002, Basic Petroleum Engineering Practices, 9.6; see also Integrated Petroleum Management—A Team Approach, (A. Sattar and G. Thakurm, PennWell Books, Tulsa, Okla., 1994)).

As used herein, “shear thinning” refers to the reduction of viscosity of a liquid (such as that portion of the flooding fluid comprising the pyruvate-rich xanthan) under shear stress. “Viscosity” refers to the resistance of a liquid such as water or oil to flow. The term “shear dependent viscosity ratio” as used herein is defined as the ratio of the solution viscosity measured at a given temperature and at a shear rate of 1 sec⁻¹ to the solution viscosity measured at that same temperature and at a shear rate of 10 sec⁻¹. The term “temperature dependent viscosity ratio” as used herein is defined as the ratio of viscosity of identical aqueous solutions of xanthans at two different temperatures, such as at 20° C. and 60° C. When discussing viscosity of compositions comprising xanthan gums, these parameters may be generally determined by use of the methods and apparatus specifically referred to in the examples or similar methods and apparatus.

As used herein, a polymeric material is considered “soluble” in a liquid if the “solution” can be passed through a 0.2 micron filter without substantial pressure buildup. One skilled in the art can appreciate that no characterization is made regarding the interaction of the individual polymer molecules with the liquid molecules in such solutions. Filterability of the solution to assess dissolution of the polymer can be determined using a method described by the American Petroleum Institute (API: “Recommended Practices for Evaluation of Polymers Used in Enhanced Oil Recovery Operations” RP63, First Edition, 1990, page 33).

The term “production well(s)” refers to well(s) through which oil and water are withdrawn from a reservoir. An oil reservoir or oil formation is a subsurface body of rock having sufficient porosity and permeability to store and transmit oil. The terms “injection well(s)” and “injector” refer to well(s) that are used to pump water or water mixtures into an oil reservoir for waterflooding purposes.

The invention relates to the recovery of oil from a subterranean reservoir using waterflooding. Waterflooding is a technique that is commonly used for secondary oil recovery from oil reservoirs. In this technique, water is injected through one or more wells into the reservoir, and as the water moves through the reservoir, it acts to displace oil therein to one or more production wells through which the oil is recovered.

According to this invention, the efficacy of waterflooding is improved through the use of a pyruvate-rich xanthan. We have found that pyruvate-rich xanthan is readily soluble in cold saline water and maintains the ability to provide a high viscosity at low shear in highly saline solutions. This is particularly apparent compared to polyacrylamide polymers, which do not maintain their viscosifying effect in salty solutions, such as greater than 10 parts per thousand TDS. Use of pyruvate-rich xanthan would be an advantage for operations on an oil platform at sea (for example, the North Sea), since the water used for flooding the oil reservoir is cold sea water and there are no or limited resources on typical platforms to heat sea water to help dissolve the polymer. Also, the pyruvate-rich xanthan does not thermally degrade at modest temperatures compared to available xanthans with lower pyruvate content, which lose their viscosifying effect after extended treatment at elevated temperatures. Thus, in one aspect, the present invention provides a flooding fluid for use in waterflooding operations comprising water and a pyruvate-rich xanthan.

The invention also relates to a method for recovering oil from a reservoir by waterflooding, through introducing an aqueous flooding fluid into the reservoir. In one aspect, the flooding fluid comprises a pyruvate-rich xanthan.
The pyruvate-rich xanthan may be prepared according to methods described in U.S. Patent Application Publication 2012/0021112, the entire disclosure of which is incorporated by reference herein.

The pyruvate-rich xanthan can be prepared using a Xanthomonas campestris strain. As used herein, Xanthomonas campestris strain (or X. campestris strain) is a strain of the bacterial species which causes a variety of plant diseases. A “derivative” of a X. campestris strain is in the current context a bacterial cell derived from X. campestris, that has preserved substantially all genomic information of the X. campestris strain—the derivative may, however, differ from the parent X. campestris strain by having recombinantly introduced genetic modifications (e.g. in the genome or in the form of a plasmid), which do not adversely affect the functionality of the xanthan gum gene cluster. A “progeny” of a X. campestris strain is a bacterial cell that is obtained by culture of a X. campestris strain—hence, the progeny may include later generation bacterial cells which are not genetically identical with the original X. campestris strain (due, e.g., to the emergence of natural recombination events, or spontaneous mutations), but which do not include any genetic changes which adversely affect the functionality of the xanthan gum gene cluster. A X. campestris strain producing xanthan gum having a high pyruvic acid content is a strain which produces Xanthan gum having a pyruvic acid content of at least 5% (w/w), preferably at least 5.3%, more preferably at least 5.5%, such as 5.5 to 7%.

The pyruvic acid to acetic acid weight/weight ratio in the pyruvate-rich xanthans may be least 0.5, preferably at least 0.6, at least 0.7, at least 0.8, at least 0.9, or at least 1.0, up to about 2. Particularly preferred is a ratio of about 0.9 to about 1.3, such as about 1.1.

The pyruvate-rich xanthans may have solubility in mixed salt brine up to the solubility limit of 350 parts per thousand (ppt) total dissolved solids (TDS), wherein solubility is measured by the ability of the solution to pass through a 0.2 micron filter. The pyruvate-rich xanthans may also have a viscosity measured at 0.1% xanthan in brine solution containing salt composition up to 265 ppt TDS at shear rate of 1 sec⁻¹ giving viscosity of at least 40 cP at 25° C. and at least 10 cp at 85° C. Additional details of the pyruvate-rich xanthan may be found in U.S. Patent Application Publication 2012/0021112, including viscosity of compositions comprising the pyruvate-rich xanthan in water with varied salt content.

Solutions of xanthan gum undergo a conformational transition during heating which is associated with the change from a rigid, ordered, generally helical state at low temperature to a more flexible, disordered random coil state at high temperatures. This conformational change was first observed as a sigmoidal change in viscosity (Jeanes, A., Pittsley, J. E. and Senti, F. R. “Polysaccharide B-1459: a new hydrocolloid polyelectrolyte produced from glucose from bacterial fermentation,” J. App. Polym. Sci., 1961, 5, 519-526). The temperature of the conformational transition increases with increasing ionic strength of the solution (Sworn, G. “Xanthan gum.” in Phillips, G. O. and Williams, P. A. (Eds.) Handbook of Hydrocolloids, Woodhead Publishing Ltd, Cambridge, 2000, 103-116). The temperature at which the conformational transition occurs has also been shown to be dependent on the pyruvic acid content of the xanthan molecule and it has been reported that the transition temperature decreases with increasing pyruvate content (Morrison, N. A., Clark, R., Talashek, T. and Yuan, C. R. “New forms of xanthan gum with enhanced properties” in Gums and Stabilisers for the Food Industry 12, P. A. Williams and G. O. Phillips (eds.), RSC, Cambridge, 2004, 124-130 and Morris, E. R. “Molecular origin of xanthan solution properties” in Sandford, P. A. and Laskin, A. (Eds) Extracellular microbial polysaccharides, ACS symposium series no. 45, American Chemical Society, Washington, D C, 1977, 81-89).

As demonstrated herein, the pyruvate-rich xanthans exhibit conformational transition behavior that is particularly useful for use in a flooding fluid for enhanced oil recovery.

Pyruvate-rich xanthan gums, having at least 5 weight % pyruvate, provide a viscosity, measured at 0.1% xanthan in brine solution containing a salt composition up to 265 ppt at shear rate of 1 sec⁻¹, of at least 40 centipoise (cP) at 25° C. and at least 10 cP at 85° C. Alternatively, such pyruvate-rich xanthan gums provide a viscosity measured at 0.3% xanthan in 1 weight % NaCl solution at a shear rate of 0.01 s⁻¹ at 23±2° C. of at least 80 Pa·s (wherein 1 Pa·s=1000 centipoise). Mixtures of xanthan gums may be used, provided that, in aggregate, the mixtures are characterized by the pyruvic acid content and viscosity described herein.

Without being bound by theory, the combination of viscosity and viscosity at high temperature of the pyruvate-rich xanthans is dependent on the pyruvate content of the xanthan. Too low pyruvate may provide solubility as defined herein and sufficient viscosity at low temperature, but would not provide adequate viscosity at high temperature.

The suitability of materials for flooding fluids may also be assessed for the following factors:

1) Retention of the polymer in solution in the rock matrix in the oil reservoir as measured using a method described by Maria de Malo and Elizabeth Lucas, “Characterization and Selection of Polymers for Future Research on Enhanced Oil Recovery”, Chemistry & Chemical Technology, Vol. 2, no. 4, 2008, pp 295-303. A suitable value for commercial use is less than 50 microgram retention of polymer per gram of rock. The pyruvate-rich xanthan compositions described herein may exhibit low polymer retention in rock matrix.

2) Thermal degradation of the polymer solution under air free conditions and at a temperature consistent with the reservoir conditions. To assess this property, the polymer solution(s) may be held in an inert bottle(s) and sampled periodically to measure the viscosity for a range of shear from 1 to 10 sec⁻¹ and as a function of time at the temperature. A desirable value for commercial use is less than 10% loss of viscosity (measured at shears of 1 and 10 sec⁻¹) over a 1 year period in synthetic sea water at 85° C. The pyruvate-rich xanthan compositions described herein have minimal viscosity loss compared to previous oil-recovery polymers when measured under these conditions.

3) Shear degradation of the polymer in solution using a method described by the American Petroleum Institute (API: “Recommended Practices for Evaluation of Polymers Used in Enhanced Oil Recovery Operations” RP63, First Edition, 1990, page 60). For commercial use of a polymer, a desirable value in this test is retention of shear viscosity greater than 90%.

4) Anaerobic biodegradation of the polymer solution using enrichment cultures inoculated with environmental samples or inoculated with microbes from culture collection that are known to degrade polymers. These enrichments should be done using different media to accentuate different metabolisms. For example one medium would use sulfate reduction for metabolism (to address sulfide formation). In this case, the microbes use the polymer as the carbon source (or electron donor) while sulfate (a common anion in the injection water) is the electron acceptor. For commercial use of a polymer, a desirable value in this test is less than 10% loss of viscosity over a 1 year period.

Accordingly, described herein is a flooding fluid useful for waterflooding comprising water and a cold-water soluble pyruvate-rich xanthan as described above. The aqueous flooding fluid for use in waterflooding, comprising about 0.007% to about 3% weight of a xanthan gum characterized by pyruvic acid content of at least 5.0% (weight/weight) in water.

The concentration may be in the range of about 0.05% to about 1% (weight/weight). The aqueous flooding fluid may comprise 0.05 to 0.2 weight % of the xanthan gum and may also include greater than 10 parts per thousand total dissolved solids (TDS).

This invention provides an advantage to existing technology in that flooding fluid comprising a pyruvate-rich xanthan as defined above exhibit shear-thinning properties such that the solution exhibits low viscosity at high shear rates and increased viscosity at low shear rates.

The flooding fluid comprises water, wherein at least a portion of said water comprises a pyruvate-rich xanthan. The water may have salinity up to 10 ppt total dissolved solids (TDS), or greater than 10 ppt TDS, or greater than 25 ppt TDS, greater than 35 ppt TDS and up to the solubility limit of mixed salts in water which is about 350 ppt. Synthetic sea water as defined by API standards has a TDS of about 30 to 40 ppt, such as 34 ppt. Typical oil reservoir brines may have from 10 to 275 ppt TDS, such as 40 to 85 ppt TDS. The ratio of divalent ions to monovalent ions may also have an impact on low shear viscosity performance of dissolved polymers. The pyruvate-rich xanthan useful in the invention exhibits particularly good rheological properties in solution. The viscosity values observed for the pyruvate-rich xanthan are superior to those of existing commercial products. The main advantage obtained from this property of the pyruvate-rich xanthan is that the amount of xanthan gum in the flooding fluid may be reduced while retaining high viscosity compared to a flooding fluid containing previous xanthan gums.

The pyruvate-rich xanthan also exhibits particularly good rheological properties in highly saline solutions.

The pyruvate-rich xanthan may have a viscosity measured at 0.1% xanthan in synthetic sea water at a shear rate of 1 sec⁻¹, and a temperature of 25±2° C. which is at least 40 cp. The viscosity measured at 0.1% xanthan in synthetic sea water at a shear rate of 1 sec⁻¹ and at a temperature of 25±2° C. may be in the range from 40 to 130 cp, such as in the range from about 45 to about 125 cp.

The pyruvate-rich xanthan may have a viscosity at a shear rate of 1 sec⁻¹ in 265 ppt TDS synthetic brine (characterized in Table 6 below) of at least 40 cp at 25° C. However, viscosity will decrease with increasing temperature. For example at 85° C. at the same shear and same polymer composition in the same synthetic brine it may be 12 cp.

Further, this invention provides a method of making an aqueous flooding fluid for use in waterflooding, comprising:
(a) providing a xanthan gum characterized by pyruvic acid content of at least 5.0% (w/w) (as described above); and
(b) adding the xanthan gum to at least one portion of water used in waterflooding.
   The pyruvate-rich xanthan can be added as a solid powder to at least one portion of the flooding fluid. The concentration of the pyruvate-rich xanthan in at least one portion of the flooding fluid can be in the range of about 0.007% to about 3% (weight of the pyruvate-rich xanthan/total weight of the at least one portion of flooding fluid comprising said pyruvate-rich xanthan). For preparing relatively small amounts of flooding fluid, the xanthan may be added in a batch process, wherein a defined weight of xanthan is added to a defined volume of water to form a solution. The xanthan solution may be produced in any suitable vessel, such as a tank, vat, pail and the like. Stirring or mixing is useful to provide effective contact of the bulk xanthan powder with water. The xanthan gum dissolves substantially completely in water at about 25° C. within about 14 hours. Preferably the solution is produced in about 1 hour or less, such as in about 30 minutes.

For larger scale operations such as waterflooding, the xanthan may be added continuously to a stream of water. Due to the good solubility of the xanthan in water, it is contemplated that the process may proceed within a pipeline in which the components of the dispersion are charged at one end of the pipeline and form the solution as they proceed down the length of the pipeline. For example, the xanthan powder may be mixed by metering solid xanthan at a defined rate with water as it passes through a pipeline, with or without added mixing, such as through static mixers. Alternatively, the xanthan may be mixed with a small portion of water to form a slurry and diluted to the final concentration by adding the slurry to additional water as they pass through a pipeline, with or without added mixing, such as through static mixers.

This invention also relates to the recovery of oil from a subterranean reservoir using waterflooding. In one aspect, the invention provides a method for recovering oil from a reservoir by waterflooding, comprising:
(a) introducing an aqueous flooding fluid into the reservoir, wherein at least one portion of the flooding fluid comprises 0.007 to 3 weight % of a pyruvate-rich xanthan gum characterized by pyruvic acid content of at least 5.0 weight % (w/w); and
(b) displacing oil in the reservoir with said flooding fluid into one or more production wells, whereby the oil is recoverable.
   Thus, in one aspect, the pyruvate-rich xanthan is added to a volume of water and injected into the well(s), optionally followed by the injection of additional water (not containing the pyruvate-rich xanthan). The at least one portion of the flooding fluid containing the pyruvate-rich xanthan exhibits low viscosity during injection into the reservoir and higher viscosity when flowing through the reservoir. This process can be repeated one or more times if necessary. At the injection well(s), which is under high pressure and high shear, the relative viscosity of at least one portion of the flooding fluid comprising the pyruvate-rich xanthan is low, whereas as at least one portion of the flooding fluid flows into the reservoir, the shear decreases and the relative viscosity increases. The pyruvate-rich xanthan can also be added to the entire volume of flooding fluid, as long as the backpressure at the injection well(s) does not become too high. As is known to those skilled in the art of oil recovery, the bottom well pressure of the injector cannot exceed the strength of the rock formation, otherwise formation damage will occur at a given flow rate. Adjustments can be made by reducing the flow of the injection water, adding water to decrease viscosity, or by adding water mixed with a pyruvate-rich xanthan to increase viscosity in order to improve the efficacy of oil recovery.

In one aspect, pyruvate-rich xanthan is added to the flooding fluid in order to increase the viscosity of at least one portion of the water in the flooding fluid, thereby improving the displacement of oil to the production well(s). To achieve optimal efficiency in waterflooding operations, it is desirable that the mobility of the water be less than the mobility of the oil. The oil mobility is calculated by the formula kₒ/μₒ, where kₒ is the relative oil permeability measured at residual water saturation and μₒ is the oil dynamic viscosity measured at reservoir conditions. Similarly, the water mobility is calculated by k_{w}/μ_{w}, where k_{w} is the relative water permeability measured at residual oil saturation and μ_{w} is the water dynamic viscosity measured at reservoir conditions. In typical waterflooding operations the water mobility is greater than the oil mobility, thus the water will tend to channel or finger through the oil. When the pyruvate-rich xanthan is added to the at least one portion of the flooding fluid as described herein, the addition of the pyruvate-rich xanthan increases the viscosity of the at least one portion of the water, thereby reducing the effective water mobility. Thus, the oil is more likely to be driven towards the production well(s).

The viscosity of at least one portion of the flooding fluid comprising the pyruvate-rich xanthan is about 30% higher at low shear rates of 1 sec⁻¹ or less than the viscosity of the same polymer in solution measured at the same temperature but at a high shear rate of 10 sec⁻¹ or greater. Consequently a figure of merit that will be used to illustrate the degree of shear thinning is the shear dependent viscosity ratio measured at a specific temperature at different shear rates, specifically at shear rates of 1 sec⁻¹ and 10 sec⁻¹. Using this figure of merit, in one aspect, this viscosity ratio for at least one portion of the flooding fluid comprising pyruvate-rich xanthan is at least 1.3, preferably at least 1.8, more preferably at least 2.0, or at least 2.5. In a stratified oil-bearing formation the permeability of different geological oil-bearing layers may differ, and as a result the injected water could initially reach the production well through the most permeable layer before a substantial amount of the oil from other, less permeable, layers is retrieved. This breakthrough of injection water is problematic for oil recovery, as the water/oil ratio retrieved from the production well will increase and become more unfavorable during the lifetime of the oil field. The addition of the pyruvate-rich xanthan to at least one portion of the flooding fluid is expected to result in less water flooding the more permeable zones in a reservoir, thus reducing the chance of fingering of flooding fluid through these more permeable zones of the oil bearing strata and improving sweep efficiency. Additional materials can optionally be added as thickening agents or surface active agents to enhance the sweep efficiency of the flooding fluid and/or reduce water mobility. These materials include at least one of the members of the group consisting of hay, sugar cane fibers, cotton seed hull, textile fibers, shredded paper, bentonite, rubber pulp, wood shavings and nut hulls, provided that these materials together with a pyruvate-rich xanthan provide the desired viscosity, concentration and/or particle size distribution.

In addition, the additional materials may include propanediol thickeners, such as one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol, as described in the commonly owned and copending U.S. application Ser. No. 12/023,166. An “oligomer” of 1,3-propanediol has a degree of polymerization of 2-6, whereas a “polymer” has a degree of polymerization of at least 7. A “homopolymer” of 1,3-propanediol is a polymer synthesized using monomers of 1,3-propanediol. A “heteropolymer” of 1,3-propanediol is a polymer synthesized using 1,3-propanediol monomers as well as one or more additional C₂ through C₁₂ straight-chain or branched comonomer diols. Additional thickeners include polyacrylamide, carboxymethylcellulose, polysaccharide, polyvinyl pyrrolidone, polyacrylic, and polystyrene sulfonates, and ethylene oxide polymers, as described in U.S. Pat. No. 3,757,863; and methyl cellulose, starch, guar gum, gum tragacanth, sodium alginate, and gum arabic, as described in U.S. Pat. No. 3,421,582. Each of the thickeners can be used alone, or in combination with one or more other thickeners as described above. Surfactants, such as acid salts of amido-acids as described in U.S. Pat. No. 2,802,785 can also optionally be added. Surfactants and thickeners can also be used in combination.

Thus, in one aspect, the additional materials that are added to flooding fluids of the invention are preferably biodegradable, such as starch, guar gum, sodium alginate, gum arabic and methyl cellulose.

The pyruvate-rich xanthan is added to a volume of water and injected into the well(s), followed by the injection of additional water. This process can be repeated one or more times if necessary. At the injection well(s), which is under high pressure and high shear, the relative viscosity of at least one portion of the flooding fluid comprising the pyruvate-rich xanthan is low, whereas as at least one portion of the flooding fluid flows into the reservoir, the shear decreases and the relative viscosity increases. The pyruvate-rich xanthan can also be added to the entire volume of flooding fluid, as long as the backpressure at the injection well(s) does not become too high. As is known to those skilled in the art of oil recovery, the bottom well pressure of the injector cannot exceed the strength of the rock formation, otherwise formation damage will occur at a given flow rate. Adjustments can be made by reducing the flow of the injection water, adding water to decrease viscosity, or by adding water mixed with the one or more pyruvate-rich xanthan to increase viscosity in order to improve the efficacy of oil recovery.

The flooding fluid can be recovered as it exits the production well(s) and at least one portion of the recovered flooding fluid can be reused, i.e., reinjected into the reservoir. Prior to reinjection into the reservoir, additional pyruvate-rich xanthan as defined above can be added to at least one portion of the recovered flooding fluid. The additional pyruvate-rich xanthan can be added at a concentration of about 0.007% to about 3% (weight of one or more pyruvate-rich xanthan/weight of at least one portion of flooding fluid). Alternatively, at least one portion of the flooding fluid exiting the production well(s) can be disposed of, for example by disposal at sea, in a disposal well, or in a wastewater pond.

### EXAMPLES

The present invention is further illustrated in the following Examples. It should be understood that these Examples are given by way of illustration only and are not meant to be limited to said Examples. From the above discussion and these Examples, one skilled in the art can ascertain the essential characteristics of this invention.

### Materials Used

Samples of xanthans of various pyruvate and acetate content as summarized in Table 1 were obtained. Some xanthans are commercially available from DuPont™ Danisco under the tradename GRINDSTED® or under various material numbers. High pyruvate xanthans have xanthate content of at least 5%, such as 5.5 to 7 weight %. In some cases, xanthans with lower pyruvate content can be obtained by hydrolysis of pyruvate-rich xanthans by adjustment of the xanthan gum broth to acidic pH and holding at elevated temperatures prior to recovery of the gum by alcohol precipitation. The reduction in pyruvate content is a function of the pH and time held at the elevated temperature. Other xanthans with lower pyruvic acid content can also be obtained commercially as indicated in Table 1. Pyruvate and acetate content can be quantified by HPLC after hydrolysis of the polymer.

TABLE 1

| | | Weight % | |
|---|---|---|---|
| Sample | Origin | Pyruvate | Acetate |
| PRX-1 | DuPont ™ Danisco | 6.49 | 5.1 |
| | GRINDSTED ® Xanthan MAS-SH | | |
| PRX-2 | DuPont ™ Danisco A35300 | 5.5-7 | 4-6.5 |
| PRX-3 | Pilot scale fermentation | 5.1 | 4.5 |
| X-1 | DuPont ™ Danisco | 3.7 | 6.2 |
| | GRINDSTED ® Xanthan 80 | | |
| X-2 | Pilot scale fermentation | 2.3 | 4.4 |
| X-3 | Pilot scale fermentation | 3.9 | 4.2 |
| X-4 | Pilot scale fermentation | 4.5 | 4.5 |
| X-6 | DuPont ™ Danisco A43300 | 1.5-3.4 | 4-6.5 |
| X-7 | DuPont ™ Danisco A45100 | 3.5-4.5 | 4-6.5 |

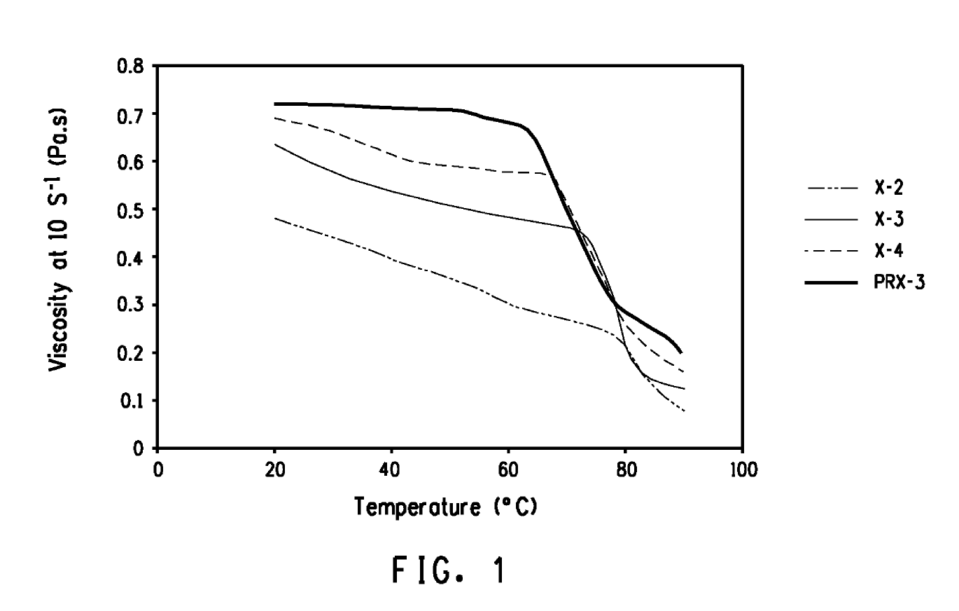

Additional non-xanthate materials include:
SG-1: succinoglycan available from DuPont™ Danisco under the trade designation A11100.
PA-1: polyacrylamide formerly available under the tradename Performa® PA 9510 from Hercules Corporation.
Samples of the various xanthans of Table 1 were dissolved in deionized water. Sodium chloride was added as powder and dissolved after hydration of the xanthan gum to prepare solutions with defined salt content. Viscosity as a function of temperature was measured using a Rheometer (Anton Parr MCR 501) at a shear rate of 10 s⁻¹, heating rate of 2° C. min⁻¹, with a 50 mm diameter, 2° angle cone. The results were plotted and representative results for solutions of 0.5% xanthan gum in 0.1% NaCl are shown in FIG. 1.
As discussed above, xanthans exhibit a conformational transition from an ordered helical structure at low temperature to a disordered random coil configuration at higher temperature. As a result, the viscosity of xanthan solutions decreases significantly when the xanthan is in the disordered state. The conformational transition can be observed where the slope of the temperature dependent line is the steepest.
The temperature dependent viscosity ratio (the ratio of the viscosity at 60° C. to the viscosity at 20° C.) of the samples is summarized in Table 2.

TABLE 2

| | X-2 | X-3 | X-4 | PRX-3 |
|---|---|---|---|---|
| Viscosity ratio | 0.65 | 0.78 | 0.83 | 0.95 |

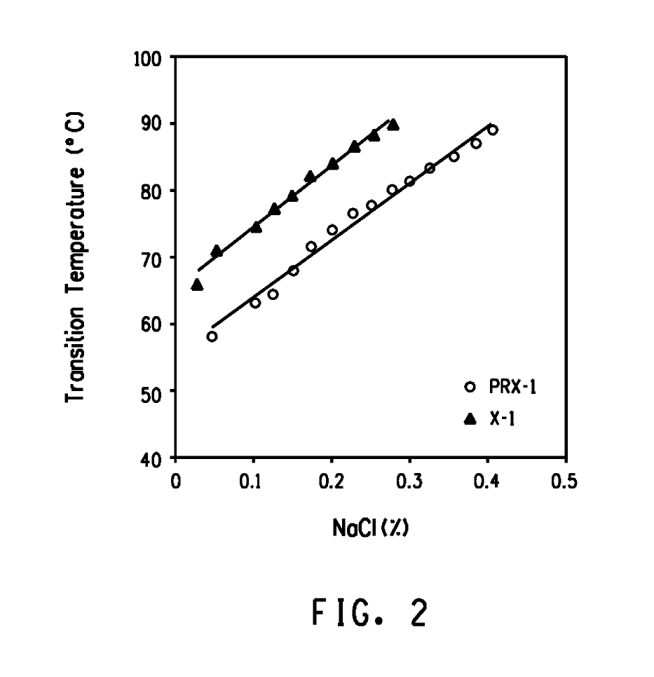

The data in Table 2 demonstrate that the temperature dependent viscosity ratio increases with increasing pyruvate content. Prior to the onset of the conformational transition, the viscosity of pyruvate-rich xanthan PRX-1, with pyruvate content over 5 weight %, is virtually constant. The temperature dependent viscosity ratio of pyruvate-rich xanthans is greater than 0.85, preferably greater than 0.90 or 0.95. This effect is independent of the salt concentration within the range studied. In contrast, the viscosity of xanthans with less than 5 weight % pyruvate decreases with increasing temperature, with temperature dependent viscosity ratios less than 0.85. Even when the salt content is increased the low-pyruvate xanthans still show a decrease in viscosity with increasing temperature. In both cases the viscosity decreases by an order of magnitude as a result of the conformational transition. Also, the viscosity above the transition temperature is significantly higher for the pyruvate-rich xanthan compared to xanthans with less than 5 weight % pyruvate. The temperature at the mid-point of the conformational transition for solutions of PRX-1 and X-1 at 0.5 weight % xanthan for was taken and plotted as a function of salt concentration and the results are shown in Table 3 and FIG. 2. The temperature of the conformational transition increased with increasing ionic strength of the solution.

TABLE 3

Transition
temperature (° C.)

| NaCl concentration (%) | PRX-1 | X-1 |
|---|---|---|
| 0.025 | | 66 |
| 0.05 | | 71 |
| 0.05 | 58.5 | 71 |
| 0.1 | 63 | 74.5 |
| 0.125 | 64.5 | 77 |
| 0.15 | 68 | 79.5 |
| 0.175 | 72 | 82.5 |
| 0.2 | 74.5 | 84.5 |
| 0.225 | 77 | 86.5 |
| 0.25 | 78 | 88 |
| 0.275 | 80.5 | 89.5 |
| 0.3 | 82 | |
| 0.325 | 83.5 | |
| 0.35 | 85 | |
| 0.375 | 86.5 | |
| 0.4 | 89 | |

The data show that the transition temperature of pyruvate-rich xanthan is approximately 5 to 10° C. lower than a standard commercial xanthan gum at equivalent salt concentrations. The temperature at which the conformational transition occurs has also been shown to be dependent on the pyruvic acid content of the xanthan molecule and that the transition temperature decreases with increasing pyruvate content. These results are consistent with the high pyruvate content of the pyruvate-rich xanthan. The salt dependence of the transition temperature is very similar for both samples as shown by the similar slope.
Solutions of the materials tested were prepared by dissolving 0.1 weight % of the material in “fresh” (deionized) water and synthetic sea water at 25° C. Each material dissolved easily in both distilled and salt water.
Synthetic sea water was obtained from VWR, catalog number RC8363-1. The major ion composition of this synthetic sea water is shown below. Other synthetic brines for specific target oil reservoirs are formulated based on ICP (inductively coupled plasma) analysis of the authentic brines and on the ion analysis (using ion chromatography analysis) and TDS analysis using refractive index.

TABLE 4
Major ion concentration of synthetic sea water RC8363-1

| Ion | Ionic concentration at 34 g/kg salinity |
|---|---|
| Chloride | 18,740 |
| Sodium | 10,454 |
| Sulfate | 2,631 |
| Magnesium | 1,256 |
| Calcium | 400 |
| Potassium | 401 |
| Bicarbonate | 194 |
| Borate | 6 |
| Strontium | 7.5 |
| Total dissolved solids | 34,089.5 |

The ratio of viscosity for each test solution was determined from viscosity measurements taken as a function of shear rate using a Brookfield DV-II+ Pro instrument (Brookfield Engineering Laboratories, Inc., Middleboro, Mass.) using a UL adaptor with water jacketed cup and remote temperature detection probe. The instrument was controlled using Rheocal software v2.7. The shear rate was varied from 0.25 sec⁻¹ to 250 sec⁻¹ at 25 and 80° C. Values of viscosity at a shear rate of 1 sec⁻¹ and 10 sec⁻¹ were used in the calculation of the shear dependent viscosity ratio. This viscosity ratio was measured at the various temperatures to match the likely range in the reservoir temperature.
The results of the viscosity testing are summarized in Table 5. In the Tables, “F” stands for fresh water and “S” stands for synthetic sea water.

TABLE 5

| | | | Viscosity at 25° C. (cP) | | | Viscosity at 80° C. (cP) | | |
|---|---|---|---|---|---|---|---|---|
| | | | | | Viscosity | | | Viscosity |
| Example | | Water | 1 sec⁻¹ | 10 sec⁻¹ | Ratio* | 1 sec⁻¹ | 10 sec⁻¹ | Ratio* |
| 1 | PRX-1 | F | 258.24 | 63.83 | 4.05 | 115.92 | 42.48 | 2.73 |
| 2 | PRX-1 | S | 151.86 | 40.64 | 3.74 | 29.35 | 16.21 | 1.81 |
| C1 | X-2 | F | 90.97 | 42.77 | 2.13 | 33.75** | 15.55** | 2.17** |
| C2 | X-2 | S | 25.68 | 12.55 | 2.05 | 11.0 | 4.77 | 2.31 |
| C3 | X-1 | F | 24.94 | 14.16 | 1.76 | 2.20 | 1.39 | 1.58 |
| C4 | X-1 | S | 16.87 | 7.63 | 2.21 | 9.54 | 2.86 | 3.33 |
| C5 | SG-1 | F | 30.81 | 14.38 | 2.14 | 11.0 | 8.18 | 1.34 |
| C6 | SG-1 | S | 257.51 | 56.64 | 4.55 | 8.07 | 2.20 | 3.67 |
| C7 | PA-1 | F | 240.0 | 65.0 | 3.69 | 87.0 | 26.6 | 3.27 |
| C8 | PA-1 | S | 2.20 | 2.42 | 0.91 | 16.14 | 1.69 | 9.55 |

*Ratio of the viscosity measured at that temperature and at a shear rate of 1 sec⁻¹ to the viscosity measured at that temperature and at a shear rate of 10 sec⁻¹
**Measured at 85° C.

The results in Table 5 show that, in general, the biopolymers tested provided lower viscosity in salt water than in fresh water. Succinoglycan SG-1 provided excellent viscosity enhancement in salt water at 25° C., but had at least a 25-fold drop in viscosity when tested at 80° C. Polyacrylamide PA-1 dramatically lost its viscosifying effect in synthetic sea water compared to fresh water. This clearly demonstrates the detrimental effect that salt water has on the performance of polyacrylamide.
The pyruvate-rich xanthan PRX-1 provides a higher viscosity in both fresh and salt water than the other biopolymers and had the most consistent performance at both temperatures tested. It also had shear dependent viscosity ratios greater than 2.0 at 25° C. and greater than 1.8 at 80° C. Commercial xanthan X-1 in salt water had a good shear dependent viscosity ratio at 80° C., but at lower viscosity levels.
Commercial xanthan X-2 had intermediate performance between that of pyruvate-rich xanthan PRX-2 and commercial xanthan X-1.
Samples of PRX-1, X-2 and X-1 were tested for the effect of heat aging on viscosity performance by preparing salt water solutions and holding them at 85° C. for a period of 20 weeks. Samples were tested for their viscosity at intervals during that period to determine whether extended heat treatment would reduce the observed viscosity. Reduced viscosity over time would indicate that the biopolymer was degrading. The apparent viscosity of solutions of the various soluble polymers in salt water was determined from viscosity measurements taken as a function of shear rate using the procedure described above. Values of the apparent viscosity at shear rates of 1 sec⁻¹ and 10 sec⁻¹ are shown as a function of time for the solution held at 85° C. in Table 6.

TABLE 6
Effect of thermal degradation on apparent viscosity
at shear rates of 1 sec⁻¹ and 10 sec⁻¹ in salt water

| | | | |
|---|---|---|---|
| PRX-2 | X-2 | X-1 | X-1 |

Concentration (Weight %)

| | | | | |
|---|---|---|---|---|
| Thermal treatment (weeks) | 0.1 | 0.1 | 0.1 | 0.2 |

viscosity (cP) measured
at 85° C. and shear
rate of 1 sec⁻¹

| | | | | |
|---|---|---|---|---|
| 0 | 18 | 8 | 23 | 83 |
| 1 | 26 | 12 | 10 | 45 |
| 4 | 26 | 16 | 16 | 29 |
| 6 | 22 | 7 | 7 | 13 |
| 8 | 16 | 9 | 10 | 14 |
| 10 | 18 | 9 | 8 | 12 |
| 12 | 25 | 8 | 7 | 12 |
| 16 | 13 | 5 | 7 | 9 |
| 20 | 14 | 6 | 6 | 9 |

viscosity (cP) measured
at 85° C. and shear
rate of 10 sec⁻¹

| | | | | |
|---|---|---|---|---|
| 0 | 10 | 4 | 8 | 33 |
| 1 | 14 | 4 | 6 | 25 |
| 4 | 14 | 8 | 5 | 20 |
| 6 | 12 | 6 | 4 | 10 |
| 8 | 9 | 4 | 4 | 8 |
| 10 | 11 | 4 | 3 | 7 |
| 12 | 9 | 3 | 3 | 7 |
| 16 | 8 | 3 | 3 | 4 |
| 20 | 9 | 3 | 3 | 6 |

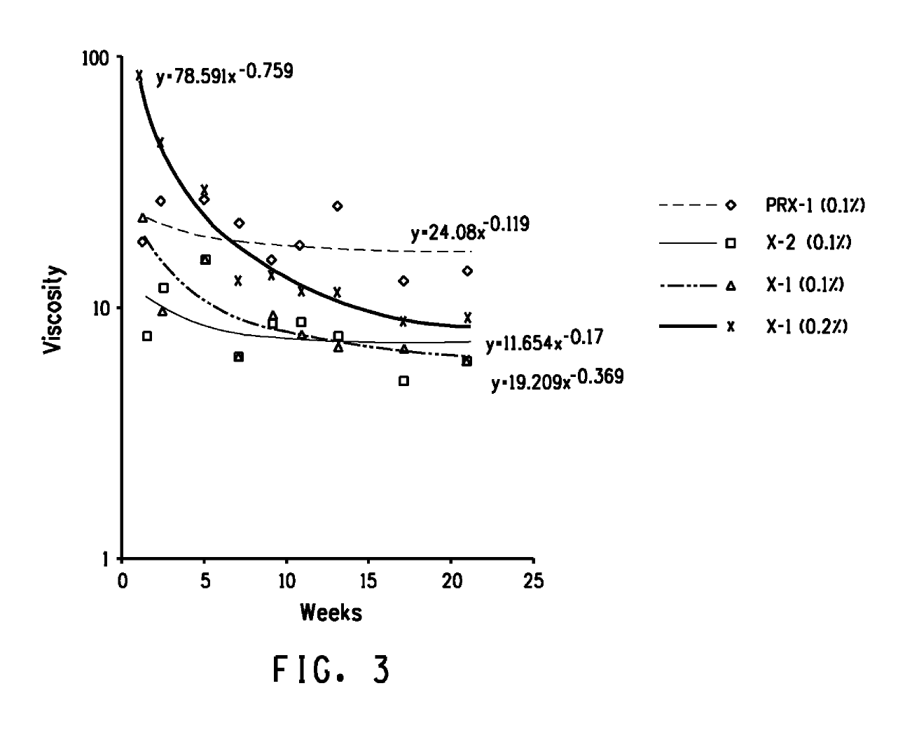

In Table 6, all polymer solutions except PRX-2 (a pyruvate-rich xanthan) showed loss of apparent viscosity with time. Remarkably, PRX-2 showed no loss of apparent viscosity. This demonstrates that it is significantly more stable to thermal degradation at 85° C. than previous xanthan gums.
The data summarized in Table 6 are plotted in FIG. 3. A least square power law fit to the 1 sec⁻¹ data shows that the PRX-2 has the least decline in viscosity versus time. That is
PRX-2 viscosity=24.08*time[weeks]“−0.119
X-2 viscosity=11.654*time[weeks]”−0.17
X-1 viscosity=19.209*time[weeks]“−0.369
X-1 (0.2%) viscosity=78.591*time[weeks]”−0.759

### Viscosity Build in Salt Brines Up to 265 Ppt.

Four additional solutions of synthetic salt brines were prepared representing a range of salt concentrations. The first synthetic brine contained 265 ppt TDS as summarized in Table 7.

TABLE 7

| Salt | Amount (g/l) |
|---|---|
| NaCl | 244.8 |
| KCl | 2.7 |
| MgCl₂•6H₂O | 16.6 |
| CaCl₂•2H₂O | 13.3 |
| SrCl₂•6H₂O | 0.4 |
| BaCl₂•2H₂O | 0.1 |
| NaHCO₃ | 0 |
| Na₂SO₄ | 0 |
| Total Dissolved Salt | 265.6 |

A second salt brine was obtained from an oil reservoir in Canada. This second salt brine had a total TDS measured by a refractometer of 71 ppt. A low salt brine was prepared by making a 1:1 dilution of this 71 ppt brine with fresh water resulting in a brine that measured as 36 ppt using a refractometer. Another low salt brine was prepared by diluting the 71 ppt salt brine with fresh water until the refractometer measured 10 ppt for this brine mixture.
Pyruvate-rich xanthan PRX-1 at 0.1 weight % readily dissolved in all five of these synthetic brine solutions. In contrast, xanthan X-2 did not readily dissolve at the highest brine concentration as evidenced by its cloudy appearance.
As in the previous examples, the apparent viscosity of these solutions of PRX-1 at 0.1 weight % in the four synthetic brines was measured from a shear rate of about 1 sec⁻¹ to over 10 sec⁻¹ and at 25° C. and 80° C. Table 8 below shows the results of these measurements. It is very remarkable that the pyruvate-rich xanthan still maintains its viscosifying effect across this wide range of salt concentrations.

TABLE 8
Effect of a range of salt concentration in synthetic brines

| | Viscosity at | | | Viscosity at | | |
|---|---|---|---|---|---|---|
| | 25° C. (cP) | | | 85° C. (cP) | | |
| | | | Viscosity | | | Viscosity |
| Brine PPT | 1 sec⁻¹ | 10 sec⁻¹ | Ratio* | 1 sec⁻¹ | 10 sec⁻¹ | Ratio* |
| 10 | 133 | 35.7 | 3.72 | 33 | 15.2 | 2.17 |
| 36 | 98 | 25.2 | 3.88 | 17.6 | 10.4 | 1.69 |
| 71 | 125 | 35.8 | 3.49 | 24.2 | 12.0 | 2.02 |
| 265 | 60.2 | 22.7 | 2.65 | 12 | 8.1 | 1.48 |

What is claimed:

1. A method for recovering oil from a reservoir by waterflooding, comprising:
(a) introducing an aqueous flooding fluid into the reservoir, wherein at least one portion of said flooding fluid comprises a xanthan gum characterized as having a pyruvic acid content of at least 5.0 weight (w/w);
(b) displacing oil in the reservoir with said flooding fluid into one or more production wells, whereby the oil is recoverable.

2. The method of claim 1 wherein the pyruvic acid content of the xanthan gum is at least 5.3% (w/w).

3. The method of claim 1 wherein the pyruvic acid to acetic acid w/w ratio of the xanthan gum is about 0.9 to about 1.3.

4. The method of claim 1 wherein the viscosity measured at 0.1% xanthan in synthetic sea water at a shear rate of 1 s⁻¹ at 25±2° C. is at least 40 cp.

5. The method of claim 4 wherein the viscosity is in the range from 40 to 130 cp.

6. The method of claim 1 wherein the xanthan gum is a product of a Xanthomonas strain selected from the group consisting of strains CFBP 19, CFBP 176, CFBP 64, CFBP 412, ATCC 17915, ATCC 19046, or CFBP 1847, or which is a product of a derivative or progeny of any one of strains CFBP 19, CFBP 176, CFBP 64, CFBP 412, ATCC 17915, ATCC 19046, or CFBP 1847.

7. The method of claim 8 wherein the xanthan gum is a product of strain CFBP 176 or of a derivative or progeny thereof.

8. The method of claim 1 wherein the xanthan gum exhibits a temperature dependent viscosity ratio at 60° C. and 20° C. of greater than 0.85.

9. The method of claim 1, wherein said flooding fluid is recovered, and wherein at least one portion of said the recovered flooding fluid is reinjected into the reservoir.

10. The method of claim 9, wherein said recovered flooding fluid is supplemented with additional xanthan gum characterized by pyruvic acid content of at least 5.0 weight % (w/w).

11. The method of claim 1, wherein said aqueous flooding fluid comprises sea water, brine, production water, water recovered from an underground aquifer, or surface water from a stream, river, pond or lake.

12. The method of claim 1, wherein the at least one portion of the flooding fluid exhibits a low viscosity during injection into the reservoir and a higher viscosity when flowing through the reservoir.

13. The method of claim 12, wherein the shear dependent viscosity ratio of the at least one portion of the flooding fluid comprising polymer is at least 1.3.

14. The method of claim 1, wherein the aqueous flooding fluid further comprises one or more members selected from the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol.

15. The method of claim 1, wherein the aqueous flooding fluid further comprises starch, guar gum, sodium alginate, gum arabic or methyl cellulose.

16. The method of claim 1, wherein the flooding fluid is disposed of at sea, in a disposal well, or in a wastewater pond.

17. An aqueous flooding fluid for enhanced oil recovery, wherein at least one portion of said flooding fluid comprises water and 0.007 to 3 weight % a xanthan gum characterized by pyruvic acid content of at least 5.0 weight % (w/w).

18. The flooding fluid of claim 17 wherein the viscosity measured at 0.1% xanthan in synthetic sea water at a shear rate of 1 s⁻¹ at 25±2° C. is at least 40 cp.

19. The flooding fluid of claim 18 wherein the viscosity measured at 0.1% xanthan in synthetic sea water at a shear rate of 1 s⁻¹ at 25±2° C. is in the range from 40 to 130 cp.

20. The flooding fluid of claim 17 wherein the xanthan gum exhibits a temperature dependent viscosity ratio at 60° C. and 20° C. of more than 0.85.

21. The flooding fluid of claim 17 wherein the pyruvic acid content of the xanthan gum is at least 5.3% (w/w).

22. The flooding fluid of claim 17 wherein the pyruvic acid to acetic acid w/w ratio of the xanthan gum is about 0.9 to about 1.3.

23. The flooding fluid of claim 17 wherein the xanthan gum exhibits a temperature dependent viscosity ratio at 60° C. and 20° C. of more than 0.85.

24. The flooding fluid of claim 17 wherein the shear dependent viscosity ratio of the flooding fluid is at least 1.3.

25. A method of making an aqueous flooding fluid for use in waterflooding, comprising:
(a) providing a xanthan gum characterized by pyruvic acid content of at least 5.0 weight % (w/w);
(b) adding the xanthan gum to at least one portion of water used in waterflooding.
